(19) United States
(12) Patent Application Publication
(10) Pub. No.: US 2017/0269570 A1
(43) Pub. Date: Sep. 21, 2017

(54) METHOD FOR CONTROLLING AN ELECTRIC ACTUATOR

(71) Applicant: ThyssenKrupp Presta AG, Eschen (LI)

(72) Inventor: Michele Sigilló, Winterthur (CH)

(73) Assignee: ThyssenKrupp Presta AG, Eschen (LI)

(21) Appl. No.: 15/514,934

(22) PCT Filed: Sep. 2, 2015
(86) PCT No.: PCT/EP2015/069987

§ 371 Date: Mar. 28, 2017

(30) Foreign Application Priority Data
Oct. 1, 2014 (DE) 10 2014 014 313.9
May 22, 2015 (DE) 10 2015 006 491.6

(51) Int. Cl. G05B 19/19

(52) U.S. Cl. CPC G05B 19/19; G05B 2219/42064; G05B 2219/42076

(57) ABSTRACT

A method for controlling an electric actuator may involve determining with a controller a manipulated variable T1 of an actuating motor, in order, starting from an actual position X as a state variable to reach a target position Xd. The method may further involve calculating a control value of the electric actuator based on the manipulated variable T1. The manipulated variable T1 of the actuating motor may be calculated by using a second time derivative of the target position d²Xd/dt² and an achieved control change ΔX|_{τ}−ΔX|₀, wherein ΔX|_{τ}=Difference target−actual position at time τ and ΔX|₀=Difference target−actual position at time t=t0.

The present invention relates to a method for controlling an electric actuator having the features of the preamble of claim 1 and, in a preferred embodiment, for controlling an electromechanical steering system for a motor vehicle having the features of the preamble of claim 17.

The classical control approaches with P controllers, PI controllers or PID controllers are not well suited to the high dynamic demands with regard to minimum control deviations and dynamic disturbance variables such as occur in operation of motor vehicles.

In steering systems with electric power assistance, also called electric servo steering systems, for example recirculating ball mechanisms are used to convert the rotational movement of an electric motor into an axial movement of the rack. In addition to the mechanical connection between steering wheel and rack, the electric motor can serve as an electric auxiliary drive or be used for steer-by-wire steering. In steer-by-wire steering systems, the steering request set by the driver on the steering wheel is not transmitted to the steerable vehicle wheels on a direct mechanical route but on an electrical or hydraulic route. According to the prior art, the steering torque applied to the steering wheel by the driver is measured by a steering torque sensor. Depending on the information about the steering torque originating from the steering torque sensor, control commands are passed on to an actuating device of the electric motor. In the case of a steer-by-wire steering system, instead of the steering torque applied, a steering angle applied by the driver is measured and control commands for the electric motor are determined therefrom in order to actuate the steering. A control algorithm calculates the necessary torque of the electric motor in order to move the rack into the desired position.

The control algorithm or the control method are preferably designed in such a way that the position of the electric drive, corresponding to the position of the rack in the case of controlling an electric servo steering system, follows the predefined target value with the least possible time delay and without over swings. In addition, it is desired that the position control has a robust control response that is insensitive with respect to internal and external disturbance variables.

Conventionally, these control algorithms on the classical control systems mentioned at the beginning are built up with P, PI or PID controllers, which are based on a linear, time-invariant mathematical description of the vehicle steering. The quality of the control depends primarily on the accuracy of the mathematical model and the linearity of the system. In the case of steering systems for motor vehicles, these classical control approaches are generally not suitable to meet the high dynamic requirements of the operation in the motor vehicle. Linearity deviations or time-dependent faults of the system, for example as a result of changes in the vehicle dynamics, which, amongst other things, depend on road and loading state, can be handled only to a limited extent by the conventional control system. These internal and external disturbance variables have a considerable influence on the stability and the control accuracy of a steering system.

It is therefore an object of the present invention to provide a control method and a corresponding control algorithm for controlling an electric actuator which has improved control accuracy with low overswings.

This object is achieved by a method having the features of claim 1 and by a steering system having the features of claim 17. Advantageous developments of the invention are illustrated in the sub-claims.

Accordingly, a method for controlling an electric actuator, in which
a manipulated variable T1 of an actuating motor is determined by a controller,
in order, starting from an actual position X as state variable
to reach a target position Xd as target position, and in which
a control value of the electric actuator is calculated on the basis of the manipulated variable T1, is provided, wherein the manipulated variable T1 of the actuating motor is calculated by using the second time derivative of the target position d²Xd/dt² and an achieved control change ΔX|_{τ}−ΔX|₀, with

ΔX|_{τ}=Difference target−actual position at timer and

ΔX|₀=Difference target−actual position at time t=t0.

The target position Xd is not to be understood as a stationary value but as a value that depends on the respective driving state. In particular, an entered steering angle is variable during the journey and, accordingly, can be represented as a function of time.

By means of this control, the actuator is actuated with improved control accuracy with low overswings.

Provision can be made for the manipulated variable T1 of the actuating motor to be calculated by using the time derivative of the actual position dX/dt.

Provision can also be made for the manipulated variable T1 of the actuating motor to be calculated by using the time integral of the deviation ΔX between the target position Xd and the actual position X in accordance with ∫ₜ₀^{t}(ΔX|_{τ})dτ.

In a preferred embodiment, the manipulated variable T1 is calculated as

$$T 1 = \frac{1}{UV} * \{ Y \} ,$$

where Y is a sum and has the summands P=μ*a1*K1*(ΔX−ΔX|₀) and

$$DD = U 2 * \frac{{d}^{ 2} Xd}{{dt}^{ 2}} * F 2 ,$$

and where the variables are defined as follows:

UV=Transmission ratio or control gain,

K1, a1=Tuning parameters,

F2=Weighting function,

U2=Weighting factor,

μ=Weighting factor.

Provision can be made for the variable Y to have the summands I1=μ*a1*η*a2*K1*∫ₜ₀^{t}(ΔX|_{τ})dτ, where the variable a2 is a tuning parameter and η is a further weighting factor.

All weighting factors, such as the weighting factors μ and η already introduced, play only a subordinate role for the implementation in software. They can readily have the numerical value 1. Physically, they serve for the adaptation of the dimensional units.

Furthermore, to improve the control behavior, provision can be made for the variable Y to have the summands

$$D 1 = K 1 * \frac{d ( Δ X - Δ X {\vert}_{0} ) }{dt} and \text{/} or D 2 = U 1 * \frac{dX}{dt} * F 1 ,$$

where U1 is a weighting factor and F1 is a weighting function.

Preferably, provision can be made for the variable Y to have the two summands

$$D 1 = K 1 * \frac{d ( Δ X - Δ X {\vert}_{0} ) }{dt} and D 2 = U 1 * \frac{dX}{dt} * F 1.$$

The variable Y can also have the summands 12=a2*K1*∫ₜ₀^{t}d(ΔX|_{τ})/dt dτ.

Furthermore, the variable Y can have the summands

$$S = ß 1 * {\int }_{t 0}^{t} SIGN [ \frac{d ( Δ X {\vert}_{τ} ) }{dt} + μ * a 1 * ( Δ X {\vert}_{τ} ) ] * d τ ,$$

where β1 is a tuning parameter.

The variable Y can additionally have the summands

$$2 = U 3 * \frac{dX}{{dt}^{ 2}} * F 2 ,$$

where U3 is a further weighting factor and F2 is a further weighting function.

In a preferred embodiment, the manipulated variable T1 of the actuating motor is calculated as

$$T 1 = \frac{1}{UV} * \{ Y \} ,$$

with Y=P+DD+I1+D1+D2+I2+S.

Provision can be made for F1 and/or F2 to be a constant function.

Provision can additionally be made for F1 and/or F2 to be determined by

cos(ω3*t)+λ*|ΔX|*[e^{(-q1*(t-t0)-q2*|ΔX|)}+cos(ω2*t)] and/or

sin(ω3*t)+λ*|ΔX|*[e^{(-q1*(t-t0)-q2*|ΔX|)}+sin(ω2*t)],

where q1 and q2 are further weighting factors.

The proposed method for controlling an electric actuator is particularly suitable for the control of an electromechanical steering system.

The state variable of the actuator is preferably the position of the rack and/or the pivoting angle of a wheel.

In an advantageous embodiment, the actuating motor is an electric motor, which transmits a drive torque to the rack by means of a gear mechanism, for example a ball-screw drive or a worm gear mechanism.

In a preferred embodiment, the manipulated variable T1 can be the torque output by the actuating motor, wherein a target current value and/or a target voltage value which is fed to the actuating motor is determined on the basis of the manipulated variable T1. However, it is also conceivable and possible to directly use the current and/or the voltage which is fed to the windings of the electric motor as manipulated variable. Corresponding conversion factors must then be provided in the calculation rules presented above.

The control method, as illustrated in patent claims 1 to 3, is also suitable to control a desired torque for the steering movement of a motor vehicle. In this case, the opposing torque counteracting the steering movement of the driver on the steering wheel (=the restoring torque or the actual torque), which is to be opposed to the driver as a reaction to his steering movement introduced into the steering wheel, can be used as the position X, which represents the state variable. Then, the torque output by the actuating motor or the current fed to the electric motor then serves as manipulated variable T1. Accordingly, the desired target torque which is intended to oppose the steering movement is correspondingly to be used as target position Xd. The desired target torque can be derived from the rate of rotation of the steering shaft and/or the change in the rate of rotation of the steering shaft, for example. In addition, still further parameters, such as for example the speed of the motor vehicle, can be used to determine the target torque. The values can be stored in predetermined tabular form or calculated with a function at run time. The actual torque can be determined in a straightforward way by using a known torque sensor in accordance with the prior art.

Also provided is an electromechanical motor vehicle steering system having a controller which is set up to a carry out a method having at least one of the features recited previously.

A preferred embodiment of the invention will be explained in more detail below by using the drawings, in which:

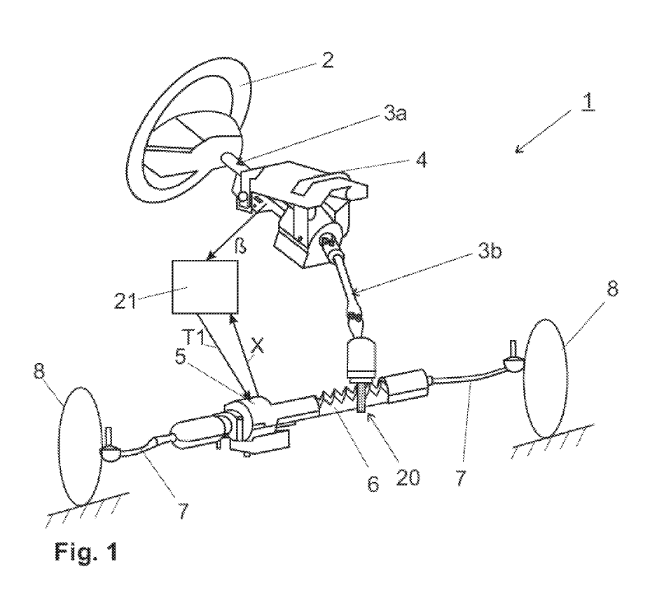

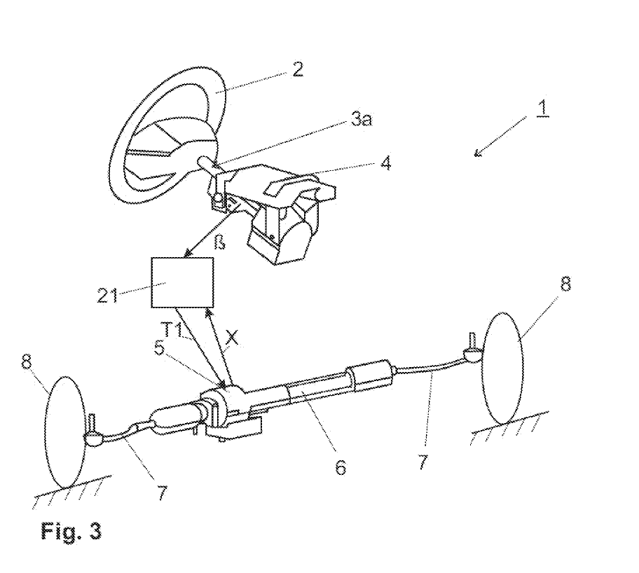

FIGS. 1 and 3: show a schematic illustration of an electromagnetic steering system, according to FIG. 1 with mechanical coupling and according to FIG. 3 of steer-by-wire design without mechanical coupling between steering wheel and steered wheels, and

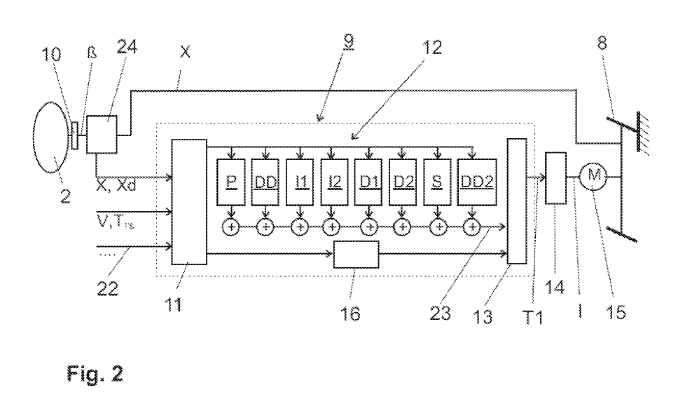

FIG. 2 shows a schematic illustration of the control of the electromechanical steering system from FIG. 1 or 3.

FIG. 1 shows a schematic illustration of a steering system 1 with electric power assistance, having a steering wheel 2, a steering column 3a, 3b, a bracket 4, an actuator 5 and a rack 6. Shown in the example is an electromechanical power steering system, in which there is mechanical access from the steering wheel 2 to a steering mechanism 20 and ultimately to the wheels 8. The steering wheel 2 is connected to the steering column 3a. The steering column 3a is mounted in the bracket 4 such that it can be displaced axially and vertically. Via a lower steering column 3b rotationally fixedly coupled to the steering column 3a, the rotation of the steering wheel is transmitted into a steering mechanism 20, by which means an axial displacement of the rack 6 and accordingly pivoting of the wheels 8 are carried out. In order to assist the steering movement, use is made as the electric power assistance of the actuator 5, which is driven via a controller 21, and assists the pivoting of the wheels 8. Also arranged in the bracket 4 is a steering sensor, not illustrated, which detects the current rotational angle, that is to say the position of the steering column 3a, and therefore of the steering wheel 2. The current rotational angle β of the steering column 3a, which is also designated as steering angle, represents a variable linked with the target position Xd in the example. In order to represent the pivoting of the wheels by the axial displacement of the rack 6, the latter is connected at its free ends to track rods 7 and coupled via these track rods 7 to steerable wheels 8. The rack 6 is displaceably mounted in its longitudinal direction in a steering housing, not illustrated. The actuator 5 for assisting the steering movement has an actuating motor M, not illustrated, and a gear mechanism. The output torque from the actuating motor M is transmitted by means of a drive shaft, not shown, of the electric motor to the rack 6 and thereby to the wheels 8. Because of the considerable forces to be transmitted, the drive shaft of the electric motor generally acts on the rack via a ball-screw drive, not specifically illustrated. However, other coupling mechanisms are also conceivable and possible, as is sufficiently well-known in the prior art. The actuator 5 is activated via an electronic controller 21. For the activation, the controller receives signals from the steering sensor via a signal line and evaluates said signals in a corresponding control unit.

The teaching according to the invention can also be applied to servo steering systems with hydraulic power assistance and to servo steering systems of the steer-by-wire type. Servo steering systems of the steer-by-wire type have no mechanical access from the steering wheel 2 to the steering mechanism 20. This would be provided in the example by a steering system in which the lower steering column 3b is not present, as illustrated in FIG. 3. The rack 6 can then also be formed as a thrust rod without teeth which, in the example corresponding to FIG. 3, is displaced exclusively via the actuator 5.

FIG. 2 shows a schematic illustration of the control unit 9 of the electromechanical power steering system from FIG. 1 or FIG. 3. The steering angle β applied to the steering wheel 2 by a driver is measured in the steering sensor 10. From this, in a signal processing unit 24, a target position Xd is determined. The target position Xd determined and an actual position of the rack 6 or of the pivoting angle of the wheel 8 is transmitted to the control unit as actual value X. In the example, the vehicle speed V and/or the torque T_{TS} applied to the steering wheel and/or further measured or calculated variables 22 are provided as possible further input variables. After pre-processing 11 of the input variables, the control section 12 follows, which finally results in an output variable 23. Following post-processing 13, the output variable constitutes a target variable, the actuating torque T1 of the electric motor. In the control system according to the invention, a respective actuating torque T1 of the electric motor is determined at a respective time. On the basis of this actuating torque T1, a respective target current I in the electric drive (PWM) 14 is then determined in a known way and is fed to the electric motor 15, which applies the torque. In parallel with the control section, specific processing steps 16 can be provided, which can also have effects on the actuating torque T1.

The actuating torque T1 is determined in the control section on the basis of the achieved change in the position deviation (ΔX−ΔX|₀) and on the basis of the second time derivative of the target position,

$$\frac{{d}^{ 2} X}{{dt}^{ 2}} ,$$

the actuating acceleration.

A further improvement can be achieved if the time derivative of the actual position

$$\frac{dX}{dt}$$

and/or the second time derivative of the target position

$$\frac{{d}^{2} Xd}{{dt}^{ 2}}$$

is/are used to calculate the actuating torque T1.

The control can be increased further if, in addition, the integral actuating change and, still further, the steering work already expended and also the fluctuation in the form of the time integration of the actuating direction are also incorporated in the determination of the actuating torque T1.

In the embodiment illustrated, the actuating torque of the electric motor T1 is calculated from the sum

$$T 1 = \frac{1}{UV} * \{ P + I 1 + I 2 + D 1 + D 2 + DD + S \}$$

of:
Proportional term (P):

P=μ*a1*K1*(ΔX−ΔX|₀)
product of the achieved change in the position deviation multiplied by a constant first factor K1;
Double differential term (DD):

$$DD = U 2 * \frac{{d}^{ 2} Xd}{{dt}^{ 2}} * F 2$$

product of the second time derivative of the target position Xd and a second factor F2, which is constant or represented by a function. This term DD corresponds to the actuating acceleration;
First integral term (I1):

I1=μ*a1*η*a2*K1*∫ₜ₀^{t}(ΔX|_{τ})dτ
time interval from the actuating position deviation, multiplied by the constant first factor K1 and multiplied by two constants μ*a1 and η*a2; this term corresponds to the actuating work instantaneously expended;
Second integral term (I2):

I2=a2*K1*∫ₜₒ^{t}d(ΔX|_{τ})/dtdτ
time integral of the time change in the actuating position deviation, which is multiplied by the constant first factor K1 and by the second constant α2; this term serves as a measure of the fluctuations that have accumulated or changes in the actuating position deviation;
First differential term (D1):

$$D 1 = K 1 * \frac{d ( Δ X - Δ X {\vert}_{0} )}{dt}$$

product of the time change in the achieved actuating change multiplied by the first constant factor K1;
Second differential term (D2):

$$D 2 = U 1 * \frac{dX}{dt} * F 1$$

product of the time change in the position multiplied by the first factor F1, which is constant or represented by a function, and multiplied by the first constant U1. This term corresponds to the actuating speed;
Integral fluctuation of the actuating direction (S):

$$S = ß1 * {\int }_{t 0}^{t} SIGN [ \frac{d ( Δ X {\vert}_{τ} )}{dt} + µ * a 1 * ( Δ X {\vert}_{τ} ) ] * d τ$$

integral of the sum of the integrated direction of the speed of the actuating position deviation and the actuating position deviation. This term corresponds the losses in the control system, in particular the friction.

The abbreviations in the formulae and in the description are defined in accordance with the following statements:

X=Actual position

Xd=Target position

ΔX|_{τ}=Difference target−actual position at time τ

ΔX|₀=Difference target−actual position at time t=t0

UV=Transmission ratio−Controller gain

K1, a1, a2, E1=Tuning parameter

ω1, ω2, ω3=Circular frequency values (preferably ω1=3/s, ω2=1/s, ω3=2/s,

where “s” denotes the dimensional unit seconds.)

U1, U2, q1, q2=Weighting factors. Here, the tuning parameters and the circular frequency values and the weighting factors are preferably all not equal to zero.

The starting point of the particularly preferred embodiment of this control is the Lyapunov stability theorem. The Lyapunov theorem states that a system becomes stable by energy being removed continuously from the system. In the case of a passive system, this removal of energy is normally carried out by friction. According to the Lyapunov theorem, here the manipulated variable is impressed on the term S. The term S corresponds to an artificially produced friction which, according to the Lyapunov stability theorem, counteracts external destabilization influences.

S can be used as a measure of the quality of the control. If the sign changes continuously, the controller is not designed accurately enough. The parameters such as the constants and factors can then be adapted appropriately. This can be carried out automatically in the controller. With automatic adaptation, adaptation to the respective vehicle and particularly to the respective driver can be achieved. In order to increase the system dynamics, the factors F1 and F2 are formed by functions.

In a first embodiment, F1 and F2 are determined as follows:

F1=sin(ω1*t),F2=cos(ω3*t).

In a second embodiment, F1 and F2 are determined by

F1=sin(ω1*t)+λ*|ΔX|*[sin(ω2*t)] and F2=cos(ω3*t)+λ*|ΔX|*[cos(ω2*t)]

where A is a further weighting factor.

And in a preferred embodiment, F1 and F2 are given by:

F1=sin(ω1*t)+λ*|ΔX|*[e^{(-q1*(t-t0)-q2|ΔX|)}+sin(ω2*t)] and

F2=cos(ω3*t)+λ*|ΔX|*[e^{(-q1*(t-t0)-q2|ΔX|)}+cos(ω2*t)].

It is conceivable and possible to replace the sin function in F1 by a cos function and at the same time to replace the cos function in F2 by a sin function.

Furthermore, it is conceivable and possible for F1 and/or F2 to use an arbitrary combination of the aforementioned functions for F1 and F2 in the controller. In particular, a constant variable or one of the aforementioned functions can be used for F1 and, likewise, a constant variable or one of the aforementioned functions can be used for F2 in the controller.

The functions F1 and F2 impress a sinusoidal or cosinusoidal excitation on the target variable and, in the case of the preferred embodiment, an exponential decay. As a result, the approach “Persistence of excitation” can be followed.

The time t is set back from t to t0 in the control when the automobile is started or if, for example, the manipulated variable is zero. The time t can also be reset from t to t0 at each beginning of the movement of the motor vehicle following a stop.

In a further embodiment, a second double differential term DD2 can additionally be used:

$$DD 2 = U 3 * \frac{{d}^{ 2} X}{{dt}^{ 2}} * F 2 ,$$

where U3 is a further weighting factor.

The manipulated variable T1 is then calculated as:

$$T 1 = \frac{1}{UV} * \{ P + DD + I 1 + I 2 + D 1 + D 2 + S + DD 2 \} .$$

In addition, still further specific processing of torque, vehicle speed, steering angle, steering angle rate and further variables can be provided in the embodiments, for example for safety functions or other special functions which play a role in the pre-processing 11 or in the special processing steps 16. It is also conceivable and possible to vary the tuning parameters on the basis of further measured variables or calculated variables, such as for example torque and/or vehicle speed and/or steering angle and/or steering angle rate and/or other variables.

It goes without saying that, in order to calculate the manipulated variable T1 by means of the controller, it is not necessary to take all of the terms enumerated into account. As already described previously, the aforementioned terms can be taken into account individually or in an extremely wide range of combinations. Thus, within the context of the development, it has been shown that the term S is not always required to represent the control. Depending on the complexity of the system to be controlled, improvements of the control behavior as compared with the prior art can already be achieved on the basis of the control method presented in patent claim 1. By means of the addition of further terms, such as are explained in the patent claims and in the description, the control behavior can in each case be improved and adapted to more complex systems.

The method according to the invention for controlling an electromechanical servo steering system for a motor vehicle has a very high control accuracy of the electric drive with very low overswings even in the event of linearity deviations or time-dependent disruptions to the system. Although the control processes only upper limits for the parameters and no exact values, high precision of the manipulated variable of the electric drive is achieved by the control according to the invention.

1.-17. (canceled)

18. A method for controlling an electric actuator, the method comprising:
determining with a controller a manipulated variable T1 of an actuating motor, in order, starting from an actual position X as a state variable to reach a target position Xd; and
calculating a control value of the electric actuator based on the manipulated variable T1, wherein the manipulated variable T1 is calculated by using a second time derivative of the target position d²Xd/dt² and an achieved control change ΔX|_{τ}−ΔX|₀, wherein
ΔX|_{τ}=a difference target−an actual position at a time τ
and
ΔX|₀=a difference target−an actual position at a time t=t0.

19. The method of claim 18 wherein the manipulated variable T1 of the actuating motor is calculated by using a time derivative of the actual position dX/dt.

20. The method of claim 18 wherein the manipulated variable T1 of the actuating motor is calculated by using a time integral of a deviation ΔX between the target position Xd and the actual position X in accordance with ∫ₜ₀^{t}(ΔX|_{τ})dτ.

21. The method of claim 18 wherein the manipulated variable T1 is calculated as
$$T 1 = \frac{1}{UV} * \{ Y \} ,$$
wherein Y is a sum and has summands
$$P = µ * a 1 * K 1 * ( Δ X - Δ X {\vert}_{0} ) and DD = U 2 * \frac{{d}^{ 2} Xd}{{dt}^{ 2}} * F 2 ,$$
wherein
UV=a transmission ratio or a controller gain,
K1, a1=tuning parameters,
F2=a weighting function,
U2=a weighting factor,
μ=a weighting factor.

22. The method of claim 21 wherein the actual position X as the state variable has summands I1=μ*a1*η*a2*K1*∫ₜ₀^{t}(ΔX|_{τ})dτ, wherein a variable a2 is a tuning parameter and η is a weighting factor.

23. The method of claim 21 wherein Y is a variable and has summands I2=a2*K1*∫ₜ₀^{t} d(ΔX|_{τ})/dt dτ.

24. The method of claim 21 wherein Y is a variable and has summands
$$S = ß1 * {\int }_{t 0}^{t} SIGN [ \frac{d ( Δ X {\vert}_{τ} )}{dt} + µ * a 1 * ( Δ X {\vert}_{τ} ) ] * d τ ,$$
wherein β1 is a tuning parameter.

25. The method of claim 21 wherein Y is a variable and has summands
$$DD 2 = U 3 * \frac{{d}^{ 2} X}{{dt}^{ 2}} * F 2 ,$$
wherein U3 is a weighting factor and F2 is a weighting function.

26. The method of claim 21 wherein the manipulated variable T1 of the actuating motor is calculated as
$$T 1 = \frac{1}{UV} * \{ Y \} ,$$
wherein Y=P+DD+I1+D1+D2+I2+S.

27. The method of claim 21 wherein Y is a variable and has summands
$$D 1 = K 1 * \frac{d ( Δ X - Δ X {\vert}_{0} )}{dt} and \text{/} or D 2 = U 1 * \frac{dX}{dt} * F 1 ,$$
wherein U1 is a weighting factor and F1 is a weighting function.

28. The method of claim 23 wherein at least one of F1 or F2 is a constant function.

29. The method of claim 23 wherein at least one of F1 or F2 is determined by cos(ω3*t)+λ*|ΔX|*+[e^{(-q1*(t-t0)-q2*|ΔX|)}+cos(ω2*t)], wherein λ, q1, and q2 are weighting factors.

30. The method of claim 23 wherein at least one of F1 or F2 are determined by sin(ω3*t)+λ*|ΔX|*[e^{(-q1*(t-t0)-q2*|ΔX|)}+sin(ω2*t)] wherein λ, q1, and q2 are weighting factors.

31. A method for controlling an electric actuator of a motor vehicle steering system with an electric auxiliary drive, the method comprising:
determining with a controller a manipulated variable T1 of an actuating motor, in order, starting from an actual position X as a state variable to reach a target position Xd, wherein the actual position X as the state variable is a position of at least one of a rack or a pivoting angle of a wheel; and
calculating a control value of the electric actuator based on the manipulated variable T1, wherein the manipulated variable T1 is calculated by using a second time derivative of the target position d²Xd/dt² and an achieved control change ΔX|_{τ}−ΔX|₀, wherein
ΔX|_{τ}=a difference target−an actual position at a time
and
ΔX|₀=a difference target−an actual position at a time t=t0.

32. The method of claim 31 wherein the electric actuator is an electric motor that transmits a drive torque to the rack by a ball-screw drive.

33. The method of claim 31 wherein the manipulated variable T1 is a torque output by the actuating motor, wherein at least one of a target current value or a target voltage value that is fed to the actuating motor is determined based on the manipulated variable T1.

34. An electromechanical motor vehicle steering system having a controller for controlling an electric actuator, wherein the controller is configured to
determine a manipulated variable T1 of an actuating motor, in order, starting from an actual position X as a state variable to reach a target position Xd; and
calculate a control value of the electric actuator based on the manipulated variable T1, wherein the manipulated variable T1 is calculated by using a second time derivative of the target position d²Xd/dt² and an achieved control change ΔX|_{τ}−ΔX|₀, wherein
ΔX|_{τ}=a difference target−an actual position at a time
and
ΔX|₀=a difference target−an actual position at a time t=t0.
